(19) United States
(12) Patent Application Publication
(10) Pub. No.: US 2019/0043486 A1
(43) Pub. Date: Feb. 7, 2019

(54) METHOD TO AID TRANSCRIBING A DICTATED TO WRITTEN STRUCTURED REPORT

(71) Applicant: EMR.AI Inc., San Francisco, CA (US)

(72) Inventors: Wael Salloum, San Leandro, CA (US); Greg Finley, St. Paul, MN (US); Erik Edwards, Oakland, CA (US); Mark Miller, London (GB); David Suendermann-Oeft, San Francisco, CA (US)

(21) Appl. No.: 15/682,434

(22) Filed: Aug. 21, 2017

Related U.S. Application Data
(60) Provisional application No. 62/541,427, filed on Aug. 4, 2017.

(51) Int. Cl. G10L 15/16; G10L 15/18; G10L 15/04; G10L 15/06

(52) U.S. Cl. CPC G10L 15/16; G10L 15/063; G10L 15/04; G10L 15/18

(57) ABSTRACT

A method for assisting the transformation of a dictated, into a structured and written, report within a specialized field. The method starts with using automated speed recognition to produce a preliminary textual representation, which it then transforms into a simplified and normalized input sequence, which it copies and then transforms the copy by replacing words with tokens appropriate to the class of word as known, rare, or reducible, thereby creating a tokenized input sequence. The method then identifies and removes any preamble from the narrative text and restores punctuation, before restoring for each token within the tokenized input sequence its separable individual and original word and thus producing punctuated narrative text for processing into the written and structured report.

### CROSS-REFERENCE TO RELATED APPLICATION

This application claims priority under 35 U.S.C. 119(e) from U.S. Provisional Patent Application Ser. No. 62/541,427, titled “Method for Assisting Transcription from a Dictated Sound Recording to Written Structured Report” by the same inventors, filed on Aug. 4, 2017.

### FIELD OF THE INVENTION

The field of the invention is that of transcription of a sound recording of a dictated report into a structured written report. Transformation of the verbal operation of speech into a structured written report is a challenge for both automated speech recognition (ASR) and natural language processing (NLP). In many occupations and technical, professional, scientific, and specialized fields the generation (and recording) of an original verbal report occurs as the speaker is engaging in another task that uses his or her hands in a fashion that interferes with or prevents the speaker from filling forms, typing letters, or otherwise directly and contemporaneously generating written text. The high value of a transformation from such verbal dictation to a written and structured report makes the use of skilled human transcriptionists economically advantageous.

### BACKGROUND

The following description includes information that may be useful in understanding the present invention. It is not an admission that any of the information provided herein is prior art or relevant to the presently claimed invention, or that any publication specifically or implicitly referenced is prior art.

The background description includes information that may be useful in understanding the present invention. It is not an admission that any of the information provided herein is prior art or relevant to the presently claimed invention, or that any publication specifically or implicitly referenced is prior art.

A verbal recording dictated by a professional, expert, or technician operating within a technical or advanced field will embody that field's particular sub-set of the speaker's language. That particular sub-set will contain terminology, field-specific idioms, field- (even sub-field-) specific abbreviations, and structural signals. In its purest form, a speech recognizer transforms spoken into written words, as exemplified in FIG. 1. Such raw output will have to undergo multiple transformation steps to change from a verbal recording to a written output that then becomes a structured report.

Such dictation will not follow the norms of conversational speech, and will not incorporate interchanges between the speaker and another individual, that govern and structure other forms of speech. A verbal dictation often incorporates metadata; sometimes (but not always) in a preamble. This metadata comprises information (names, location, context and name of the source, date of the action described in the report, etc.) not intended to be copied into the report's narrative text. The metadata enables that dictation to be reconnected with a particular written record or file, in case this connection is not continuously and physically effected, or when an error in connection needs correction. Handling, and transcribing, preambular metadata requires detecting it; and detecting preambular metadata is a problem where even the “gold standard” of skilled human transcriptionists can struggle to reach agreement. This has been one of the tasks generally effected by skilled human transcriptionists, with particular knowledge in a specific technical field (e.g. medical report transcription).

One definition of a gold-standard annotation was where at least three skilled human transcriptionists agreed on the exact split between a dictation's preamble and narrative text. FIG. 2 shows a histogram of the frequency of number of agreements in one study. Out of the 10,517 reports tested, 5,092 had all annotators agree on the split position while only 5 reports had 5 different annotations. 4.4% of the reports were not annotated by all five annotators, with this lack of annotations presumably either due to annotators not being sure how to split, or to oversight by some subset of transcriptionists. This study revealed that the lack of guidelines deliniating the specific types of phenomena featured in a preamble (e.g. including or excluding an report subject's employer), led to disagreements that ultimately caused the exclusion of reports. Nearly half of included reports had at least one dissenting opinion.

A feature of any written report is that it also contains and uses metadata—data describing describes the report that is not its content (i.e. its ‘narrative text’). Such metadata may include any, some, or all of the report's function, purpose, context, creator, creation time, transcription trace, recipient(s), routing history, and structure. Each report—even each version thereof—may have additional metadata. For example, this patent application has its own metadata (title, inventors, home cities, sub-headings, and paragraph numbers). In a verbal dictation such preamble metadata may or may not exist. Overall such metadata is not generally useful in effecting the transformation from verbal to written narration, as it does not relate to the particular vocabulary of the field of the narrative text and can burden both the ASR and NLP functions; it can even complicate and impede each of the ASR and NLP processing. An example of an output transcription with the preambular data isolated and highlighted is shown in FIG. 3.

For any technical field, a particular concern for ASR is the specific challenge produced by a large domain-specific vocabulary, which makes it difficult if not impossible to apply tools developed for general-domain text. When building a system from scratch, however, several factors conspire to make it hard to obtain enough training data: the large field-specific technical vocabulary increases problems related to data sparsity and the handling of out-of-vocabulary (OOV) terms; the data often contain sensitive information and have restricted access or availability; and modern methods, such as neural networks as used here, typically require large amounts of prepared training data. Reducing the vocabulary that must be processed at any step will reduce the complexity and speed the processing—for machine and human transcriptionist.

A linked problem for ASR is achieving useful speed in the transformative processing. As the vocabulary scales upward, the number of model parameters necessary to accurately compute the transformation scale up proportionately, which means that the computational cost (in time and complexity) likewise soars; but speed and accuracy are each is crucial for fast decoding. Recognizing and restoring punctuation—which can be absent in a verbal recording—provides useful context that speeds both word recognition and transformation into a written report.

Particularly when considering the issues of crafting automated assistance for transcription, identifying the preambular metadata so it can be analyzed and effectively used, yet not burden the narrative text transformation by increasing the ‘vocabulary’ used by the NLP, is essential. Furthermore, however much a speaker may intend or even strive to incorporate punctuation, the accurate comprehension of even omitted punctuation can greatly complicate both ASR and NLP processing. The content and context of the text may itself form the report-specific ‘rules’ whereby the speaker implies but fails to expressly incorporate punctuation. Whenever there is gap between what is implied and not expressed, even the most skilled transcriptionist may have trouble as there is no way to read the speaker's mind at that remove. Even so, there can be cues present in the overall dictation that if decoded can aid the transcriptionist; cues which may be learned and used to interpolate and (re)-place the non-specified but implied punctuation intended by the original speaker.

Multiple layers of increasingly detailed, precise, and computationally-complex analysis are usually quite important to effect the best performance for the least cost. No matter how large a fraction may be of the entire potential source material, secondary processing only occurs on a fraction of that data; and an even smaller sub-fraction may eventually be effectively transformed from a sound recording to a written report which subsequently can be any of stored, shared over a network, subjected to further processing, and any subset of the above.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply. Where a definition or use of a term in a reference that is incorporated by reference is inconsistent or contrary to the definition of that term provided herein, the definition of that term provided herein is deemed to be controlling.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for a method to aid transcribing a dictated, to a written, structured, report.

### SUMMARY OF THE INVENTION

The inventive subject matter provides an automated assistant scribe taking form in a method which transforms spoken information from a professional (or expert or technician) operating within a technical or advanced field, either directly as the professional dictates or from the sound recording of that dictation, using automated speech recognition to produce a preliminary textual representation. It then transforms the preliminary textual representation into a normalized input sequence with reduced complexity by isolating its separable original words and concatenating these into a pre-reduction input sequence, replacing numerical elements and tuples expressed as individual words in the copy to a constrained subset of tokens, and replacing variant instances of abbreviations in the copy with an additional token, thereby forming a normalized input sequence. It next applies a second transformation that replaces individual words in the copy with the appropriate token for one of the three classes of known vocabulary, rare word, and reducible word, thereby creating a tokenized input sequence; and identifies in the tokenized input sequence any preamble containing metadata to be excluded from the narrative text portion of the written report. Having done so, it removes that preamble from the tokenized input sequence. It restores punctuation to the tokenized input sequence and then restores for each token within the tokenized input sequence its separable individual and original word present in the pre-reduction input sequence, thereby transforming the tokenized input sequence into punctuated narrative text for processing into the written and structured report.

This method for improving automated transformation of spoken information comprising narrative text, into a written and structured report, comprises multiple steps. The method begins by transforming the spoken information using automated speech recognition to produce a preliminary textual representation. Then it transforms the preliminary textual representation into a normalized input sequence with reduced complexity by isolating its separable original words and concatenating these into a pre-reduction input sequence. It takes this pre-reduction input sequence and replaces its numerical elements and tuples that are expressed as individual words in a copy to a constrained subset of tokens, and replacing variant instances of abbreviations in the copy with an additional token, thereby forming a normalized input sequence. Then it applies a second transformation that replaces individual words in the copy with the appropriate token for one of the three classes of known vocabulary, rare word, and reducible word, thereby creating a tokenized input sequence. It next is identifying in the tokenized input sequence any preamble containing metadata to be excluded from the narrative text portion of the written report; and on finding any, will be removing that preamble from the tokenized input sequence; and, finally, restoring punctuation to the tokenized input sequence. It finishes with restoring for each token within the tokenized input sequence, its separable individual and original word present in the preliminary textual representation, transforming the tokenized input sequence into punctuated narrative text for processing into the written and structured report.

Various objects, features, aspects and advantages of the inventive subject matter will become more apparent from the following detailed description of preferred embodiments, along with the accompanying drawing figures in which like numerals represent like components.

While the application of neural networks (NNs) to NLP and ASR has been tried, the field still struggles to obtain performance gains and increased generalizability with neural networks (NNs). Collobert and colleagues (Collobert and Weston, 2008; CoHobert et al., 2011) successfully applied NNs to several sequential NLP tasks without the need for separate feature engineering for each task. Their networks featured concatenated windowed word vectors as inputs or, in the case of sentence-level tasks, a convolutional architecture to allow interaction over the entire sentence. However, this approach still does not cleanly capture nonlocal information.

Many linguistic problems feature dependencies at longer distances, which implementations using long short-term memory (LSTM) are better able to capture than convolutional or plain recurrent approaches. Bidirection LSTM (Bi-LSTM) networks (Graves and Schmidhuber, 2005; Graves et al., 2005; Wollmer et al., 2010) also use future context, and recent work has shown advantages of Bi-LSTM networks for sequence labeling and named entity recognition.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a textual representation of the raw output of a speech recognizer, which is the first stage of transforming a verbal dictation into written text.

FIG. 2 is a histogram of the maximum number of exact agreements obtained for a set of annotated reports, as to where the preamble and narrative text divided.

FIG. 3 is a textual representation of a dictation where the speaker is intertwining preamble and narrative text.

FIG. 4 is a textual representation of the output of a transformation from a verbal dictation into structured written text (a medical report) with preambular data separated and highlighted.

FIG. 5 is a drawing of a neural net (NN) stack using Bi-LSTM. An embedding at each word step is fed into forward and backward LSTM layers, which are fully connected to a softmax-activated output layer. (For the unidirectional LSTM, the backward layer is omitted.)

FIG. 6 is pseudo-code for a simple heuristic secondary system to detect a preamble.

FIG. 7 is the deep neural network design described below that is used in punctuation restoral.

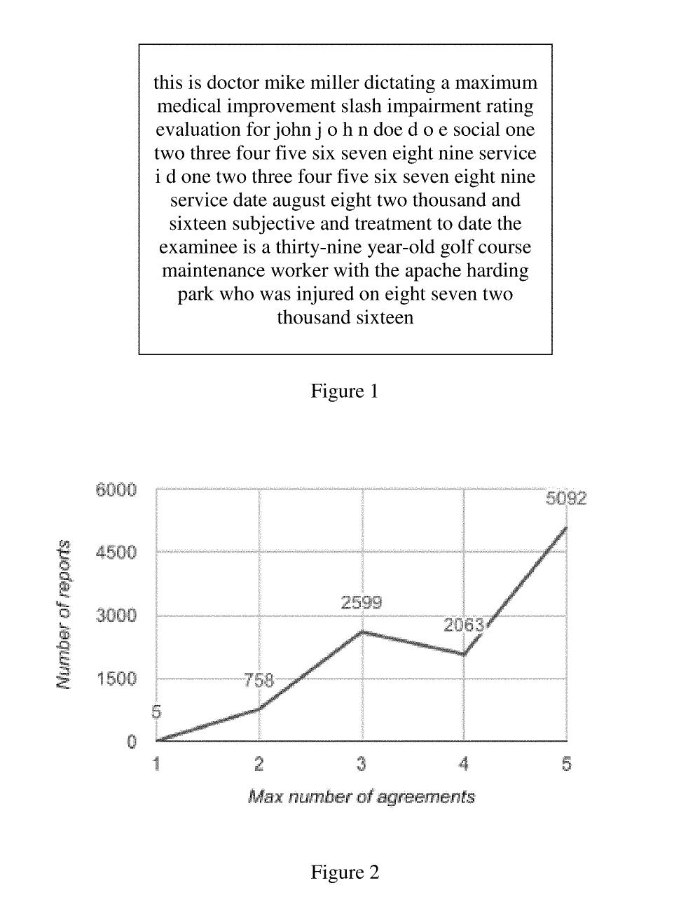

### DETAILED DESCRIPTION

Both the source verbal dictation and the final written report it is transformed into are structured; a key factor is that elements of the structure will not be coded directly in the individual vocal and graphical elements. Transforming the first into the second is more effectively assisted when the assistant works with both the structure and the content.

A ‘word’ is the smallest unit (of either speech or text) with objective or practical meaning; yet there are elements of speech (intonation, emphasis, pause length and relative pause length) and text (spacing, lineation, and punctuation) which are not “words” as such, yet which are necessary to comprehend and use in transforming the first into the second.

A word can be a simple stem; or it can be complex, when it is an agglomeration of a stem combined with one or multiple affixes (the most common are prefixes and suffixes). Words and the non-word elements of both verbal dictation and the final report can be represented as a sequential linear list, or string, that possesses a start, length, a unique ordinal position for each element, and an end. In specialized fields, elements that are ‘words’ may be comprised of abbreviations (e.g. ‘p. r. n.’ for ‘as the patient requires’; ‘hrly’ for ‘hourly’; ‘q.5+h’ for “dose q every five hours”), and specialized tuples, or ordered sequences, exist for data-centric elements (e.g. “08-02-2017” for a date; “176/95” for a blood pressure. Abbreviations may vary (e.g. “p.r.n.” and “p.r.n”, or “hrly” and “h-ly”), even for the same speaker.

Not all languages use characters, or character combinations, to form words. Abjad text requires the correct inferral of non-present vowels between characters, complicating the transformation as vocabulary recognition becomes more problematic. An ‘affix’ should be understood to incorporate in its definition the equivalences for character strings in an alphabetic grapheme, sub-strokes and combinations thereof known within the general class of vocabulary relevant to the field of the narrative, as can be understood from that contained in the definition for Orthography, establishing these equivalents. See https://en.wikipedia.org/wiki/Affix, the sub-part “Orthography”; cf. the distinction between phonemes, graphemes, and morphemes, also described in Wikipedia. In further embodiments the identification of a separable original word comprises any of character-driven recognition, stroke-order-driven recognition, and vector-characteristic-driven recognition, of the word, depending in part on the source language for that word and NLP and ASR implementation used.

Processing individual words in the dictated report that have been transformed into written text is done to reduce the number of rare and OOV words, by examining the words and replacing complex words using any combination of a special set of those prefixes and suffixes that capture the semantic and morpho-syntactic information of infrequent words in the field and in the training data (such as medical terminology and proper names), with stem-based tokens. For every input word consisting of alphabetical characters only, a vocabulary reducer goes through the special set of prefix and suffix lists and tries to match them to the beginning or end of the word, while ensuring that the stem is at least four letters long. By starting from the longer affixes to the shorter ones, the processing is greatly speeded up as the unprocessed length of any individual word drops by the largest feasible step at each stage, thus reducing the sub-length needing to be processed and causing a successful reduction at the earliest possible moment.

If the word starts with a prefix p+ of the prefix list it will be replaced with “pAAAA” (where “AAAA” represents an alphabetical stem). If it ends with a suffix +q of the suffix list, it is replaced it with “AAAAq”. Finally, if the word matches a prefix p+ and a suffix +q, it is split into two tokens “pAA+” and “+AAq”, respectively, to ensure that the information in them gets modeled separately; while these tokens are considered unified when the tokens are replaced by the original words.

Put together these aspects of vocabularly processing mean an 80% (four out of five) reduction in the vocabulary size that the deep neural network must deal with, as individual words are replaced with a class or a RARE token.

This approach can also be describes as replacing individual words in the copy with the appropriate token for one of the three classes of known vocabulary, rare word, and reducible word, thereby creating a tokenized input sequence, by effecting for each word in the normalized input sequence the following steps of: applying a vocabulary reduction algorithm working from the longest to the shortest length of affixes that capture the semantic and morpho-syntactic information of the vocabulary used in the field of the narrative text which compares these affixes against that portion of the word containing the length of that affix plus four characters; upon finding a first match for an affix, replacing the matched characters forming that portion of that word with a token for that affix; repeating the comparison until the first of (i) finding a match for all characters but four of the word, or (ii) completing a comparison of all affixes, occurs; if any match has been found, replacing characters not in the found affix with a stem token consisting of a positive and even-number of characters; if only one class of affix has been found, concatenate affix and stem tokens as a single token, assign it the position of that word in the normalized input sequence and return that token; if both a prefix and a suffix have been identified for a word: split the stem token in its middle into a first and second part; concatenate an ending split token to the end of the first part; and, concatenate to the front of the second part a starting split token; and, return both parts, assigning to each the position of that word in the normalized input sequence; but if no match for any affix has been found, replace that word with a standard stem token to which is appended a length token determined by the count of graphemes for that word and then returning that, assigning to it the position of that word in the normalized input sequence

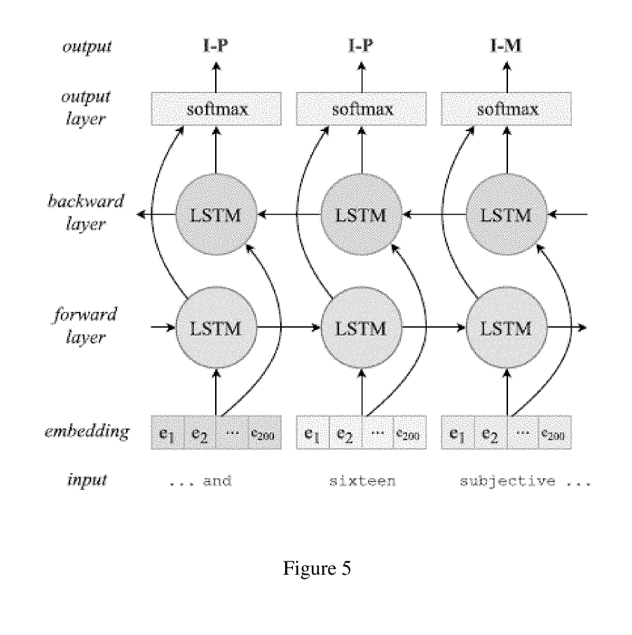

The method described herein uses a two-step approach to preamble detection. First, a sequence tagger labels every word in a subset of the dictation, the input sequence, with one of two tags: I-P (Inside Preamble) (FIG. 5, [1]) and I-M (Inside Main) (FIG. 5, [3]). This tagger leverages the large number of tokens in our data, as opposed to the small number of example reports, which leads to near perfect tagging accuracy.

Second, a report splitter determines heuristically (biasing towards inclusion of narrative text to avoid loss of information) at what position to split the tagged report into preamble and main. This splitter attempts to correct the tagger's mistakes.

The tagging is performed by a stack consists of an embedding layer (see infra for details)(FIG. 5, [5], a (Bi-)LSTM layer (FIG. 5, [6]), and a time-distributed dense layer with softmax activation (FIG. 5, [7]). As the correct prediction of tags depends on the location of words in the dictation in part, instead of tagging the input sequence using a sliding window like in the prior art, this method uses a fixed size input from the whole dictation (an initial input sequence), comprising the first 512 tokens. Words after this limit are truncated and padding is added for reports with less than 512 tokens. This initial input sequence is processed with the RNNs (FIG. 5, [9a] and [9b]) within the Bi-LSTM taking for each token an embedding of a subsequence of the words in the input sequence, from the location of that token, with that subsequence comprising word vectors of 200 dimensions trained over 15 iterations of the continuous bag-of-words model over a window of 8 words.

The combination of tagging and report splitting enabled the automated transformation to exceed the effectiveness of the gold standard, skilled human transcriptionists; whereas human split accuracy was determined to be 86.04% correct in the task of preamble detection, the method (which used both the Bi-LSTM and frozen embeddings in the embedding layer, performed with 89.84% accuracy.

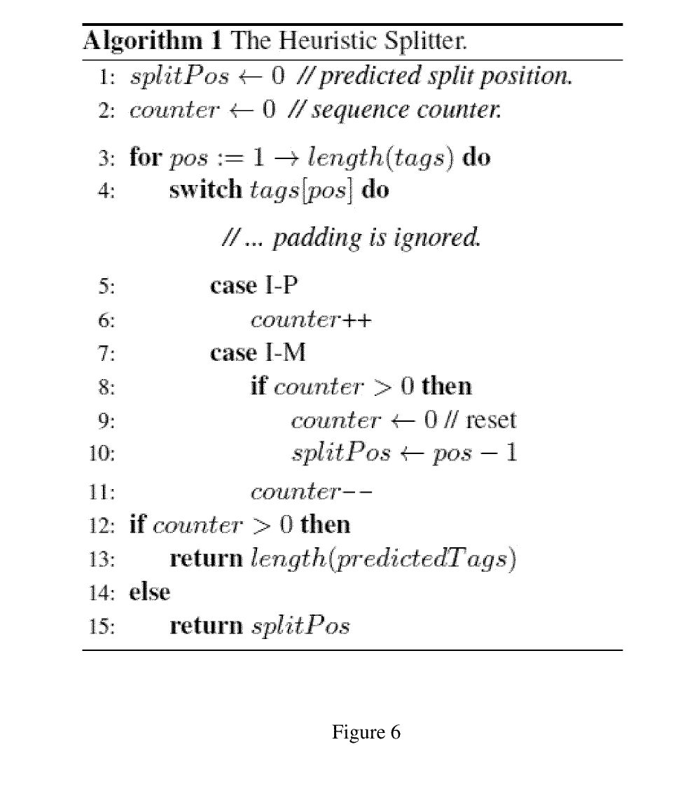

Identifying in a tokenized input sequence any preamble containing metadata to be excluded from the narrative text portion of the written report, comprises creating from the tokenized input sequence an initial segment of a fixed size; initializing a split tag with a zero value; assigning to the token in the initial segment having an ordinal value of the split tag plus one, a tag given a binary value of positive or negative depending on whether that token is inside a preamble or inside a main text sequence; if that token has been assigned a negative tag, returning the value of the split tag, but if that token has been assigned a positive tag, incrementing the split tag by one; repeating the step of assigning the binary tag for each token in the initial segment until either the value of the split tag has been returned or is equal to the fixed size; and, identifying all tokens in the tokenized input sequence whose ordinal value is less than or equal to the split tag as belonging to the preamble and all others as belonging to the narrative text. (FIG. 6)

The more specific aspect of assigning the ordinal value of the split tag depending on the latter's positive or negative value, further comprises for each token taking from the location of that token an embedding of a subsequence of the words in the normalized input sequence; feeding that embedding into a pretrained bidirectional long short term memory neural network (Bi-LSTM) fully connected to a softmax-activated output layer that produces the binary value; not enabling backpropagation to update the pretrained embedding layer after that embedding has been fed into the Bi-LSTM; and, attaching the tag produced by the Bi-LSTM to the token. The nature of this subsequence might comprise word vectors of 200 dimensions trained over 15 iterations of the continuous bag-of-words model over a window of 8 words, or any variation thereof which was effective for the NN.

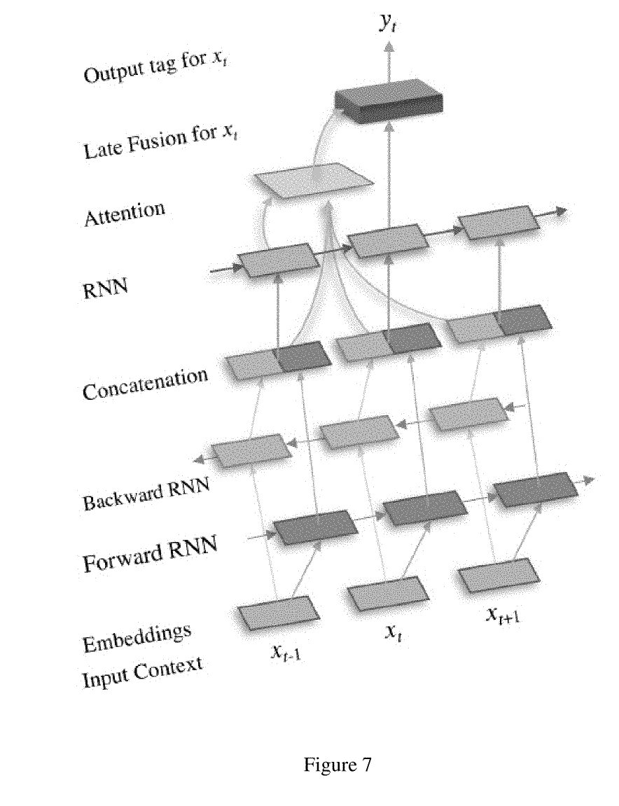

In dealing with the vocabulary recognition and simplification, the method uses a deep neural network which comprises a bidirectional recurrent neural network (B-RNN) (FIG. 7, [20]) with gated recurrent units. B-RNNs help in learning long range dependencies on the left and right of the current input word. The B-RNN is composed of a forward RNN [21] and a backward RNN [22] that are preceded by the same word embedding layer [23]. A sliding window of 256 words are passed to the shared embedding layer as one-hot vectors. On top of the B-RNN, is stacked a unidirectional RNN [25] with an attention mechanism [27] that assists in capturing relevant contexts that support punctuation restoration decisions. Finally, to effectively produce the output the method uses late fusion [29] to combine the output of the attention mechanism with the current position in the B-RNN without interfering with its memory. The design of this deep neural network is shown in FIG. 7, that shows an input context for the word xₜ and the stack of layers that result in the tag yₜ [31] representing the punctuation decision for xₜ. The default decision is that no punctuation needs to be restored after any word.

To improve the modeling of rare words and to deal with OOV words in the test and development sets, the method incorporates a step mapping many OOV words to common word classes, thereby reducing the overall size of the vocabulary. This vocabulary reduction allows a reduction the number of parameters, which is crucial for fast decoding in a live recognizer.

The method further processes individual words that are rare to a single common token (e.g. “RARE”). Together with the prior step this significantly reduces the size of the vocabulary needed to process both individual words and the entire transformation, and to replace vocabulary with a greater number of tokens, simplifying the overall recognition and processing problem for the deep neural network.

Additionally, this method uses word vectors pretrained on large amounts of unlabeled text collected from the specialized field of the dictation (e.g. medical reports and medical dictation transcriptions, for medical field; engineering analyses and engineering failure reports, for an engineering field). This transfer learning technique is often used in deep learning approaches to NLP since the vectors learned from massive amounts of unlabeled text can be transferred to another NLP task where labeled data is limited and might not be enough to train the embedding layer.

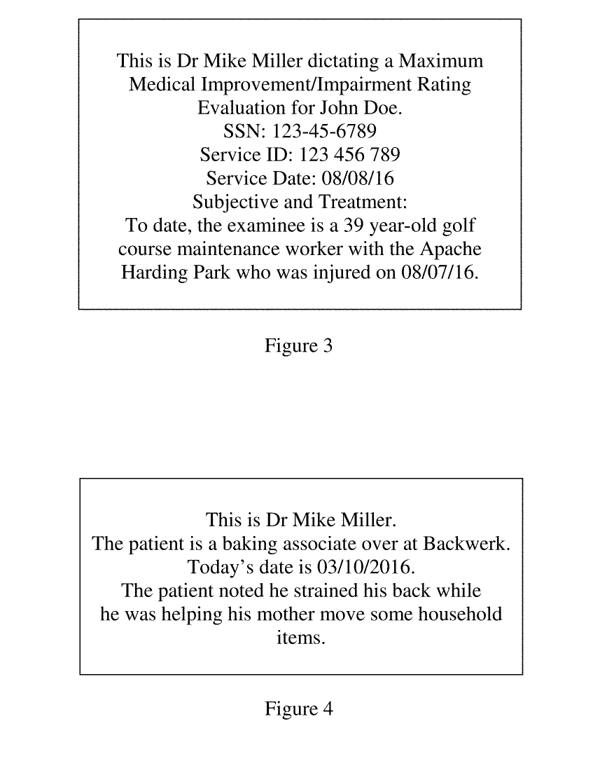

Because the stack sometimes produces mixed sequences of I-P and I-M (quite possibly because the source dictation does, as shown in FIG. 3), the method incorporates another system to find the exact position in which to split the preamble from main report using a simple heuristic to determine the split position.

That system implements an algorithm (shown in pseudo-code in FIG. 6) that looks for concentrations of preamble and main tag sequences. It initializes the split position it is trying to predict, splitPos, and a sequence counter, counter, to 0. While scanning the tagged sequence, it increases counter if it sees an I-P (Line 6) and decreases it if it sees an I-M (Line 11). counter>0 means that we have seen a long enough I-P tag sequence since the last I-M tag to consider the text so far to be preamble and the previous I-M tags to be errors. However, the next I-M tag will set restart the counter (Line 9) and set splitPos to the previous position (Line 10). Lines 12-13 handle the edge case where the sequence ends while counter>0, which means that the whole report is preamble.

It is important to point out that this method's splitter is biased by design to favor including more words in narrative text (i.e., shorter preambles). The reason for this bias is that in applications where the main text is more valued than preamble (e.g., to create a formatted note), the method takes the safe option not to omit content words. It also is worth noting that in a further embodiment the method will be using the split tag to infer and effect the placement of a colon at the end of the preamble and immediately preceding the narrative text. Another and further embodiment would implement this sub-step by allowing multiple preamble portions, or preamble portions expressed within the tokenized input sequence, to be the subject of multiple elisions of preambular sub-sequences in the source dictation (perhaps by re-examining this issue after the punctuation has been replaced and restarting the splitter after each period); and yet a further embodiment could be parallel sub-examinations with recursive calls to this step as each will have, in effect its own ‘split tag’.

It has been demonstrated that recurrent neural networks can restore punctuation very effectively (Tilk and Alumae, 2015, 2016). Such methods are promising because they should be able to handle long-distance dependencies that are missed by other methods. While using pauses showed to help in punctuation restoration for rehearsed speech such as TED Talks (Tilk and Alumae, 2016), Deoras and Fritsch (2008) note that medical dictations pose a particular challenge because the speech is often delivered rapidly and without typical prosodic cues, such as pauses where one would write commas or other punctuation. Thus, although acoustic information has been successfully incorporated for other domains (Huang and Zweig, 2002; Christensen et al., 2001), the same may not be feasible for specialized field dictation, so it is especially desirable to have a reliable text-only method.

Restoring punctuation to a text sequence—particularly, to a tokenized input sequence, is done in this method by processing that sequence and, for each token therein, feeding that embedding into a pretrained bidirectional recurrent neural network (BRNN) with gated recurrent units that establish long range dependencies for the word represented by that token; concatenating the output of both separate directional recurrent neural networks (RNNs) of the BRNN; feeding that concatenation to a pretrained separate RNN having an attention mechanism to assist with capturing relevant contexts; applying, to both the concatenation and the pretrained separate RNN, for each token at its location within the tokenized input sequence, an attention mechanism; effecting a late fusion combining the output of the attention mechanism and the current position of that token within the tokenized input sequence being processed by the BRNN without interfering with its memory, that produces the punctuation decision identifying whether any punctuation element should be present and if so, which specific punctuation element should be present after that token in the tokenized input sequence; and, then inserting after that token an output representing the punctuation decision. In yet a further embodiment, the method uses separable processing of the embedded subsequence in any RNN using a context determined by the length of the subsequence.

The step of restoring punctuation can be performed to a tokenized input sequence, rather than the original dictation or its preliminary textual representation. This approach greatly reduces the complexity of this processing by reducing the OOV processing. This aspect of the method comprises identifying for each token within the tokenized input sequence whether any punctuation element should be present after that token and, if one should be present, further identifying which specific punctuation element (preferentially from a subset of all punctuation elements, comprising period, colon, and comma) should be present, and then placing that specific punctuation element after that token. A default decision is that no punctuation will be placed after a token unless a replacement is specifically identified—for the majority of words are not located before punctuation marks.

After placing the specific punctuation element after a token, the method will return to the next steps described above of restoring for each token within the tokenized input sequence its separable individual and original restoring word present in the pre-reduction input sequence, and transforming the tokenized input sequence into punctuated narrative text for processing into the written and structured report.

Another element of the method that drives directly at reducing complexity, and thus processing requirements (time, memory, calculation, and any combination thereof, and thus improves directly the computational efficiency of any implementation), is its reduction of the vocabulary that must be used by the method (and most particularly by the RNNs therein) to effect these transformations. As matching linear lists is not only not subject to combinatorial or factorial explosion, but can often trade parallel processing (with its overhead increase) for linear computational time, it provides any number of potential efficiency gains in use of computational resources (time, processing speed, memory, bus transference, and splitting and reintegration) through balancing implementations well-known in the art, from Knuth's seminal Art of Computer Programming onwards.

In a further embodiment, the method could effect the detection of preambular or other metadata vocalized elements that occur in more than the initial segment of the dictated recording. With any of ordered and parallel processing, it would be feasible to restart the process after every period once one has been restored, with each being a complexity of Order(1) run along the separate sub-portions, thereby effecting multiple elisions of preambular sub-sequences before the vocabulary reduction processing is done.

One of the concerns with any implementation of a neural network is that of training the network. In this method, when it comes to the NNs that are used to reduce the complexity of the vocabulary, the method prefers training each RNN to replace a word with its rare class whenever that word is found no more than twenty times in any set of training data; and, omitting, whenever a word is found no more than one hundred times in any set of training data, the step of applying a second transformation that replaces individual words in the copy with the appropriate token for one of the three classes of known vocabulary, rare word, and reducible word, thereby creating a tokenized input sequence; thereby reducing processing time and memory requirements for vocabulary reduction and consequently speeding the processing for all remaining transformations.

For an implementation in a given specialized field (e.g. civil engineering, pharmacology, medicine), the training for the method should implement its NN training using source material from that field. For example, for training a method to assist medical transcriptionists, the method would be deriving the training data from unlabeled text collected from a selection of medical reports and medical dictation transcriptions; and; using the training data to train each RNN before its first use in an application of this method.

The source of that training data is also worth considering. The dictations which will be transcribed will most likely come from multiple authors and cover multiple subjects (of the activity which each author is engaging in, i.e. multiple patients over time). Thus the training data will be more useful when the method is deriving the training data from any of: collected dictations by a single author over multiple subjects; collected dictations by multiple authors over a single subject; collected dictations by multiple authors over multiple subjects; and, collected dictations by any of single and multiple authors over a specific class of subject comprising any of interview, examination, treatment, syndrome, symptom, location, any of sourcing, reporting, and treating organization including all subsets even proper subset thereof, and time intervals.

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should appreciate that the technical effect of these implementations, is to improve the computer processing (in any of time, memory, and operations requirements) for any specific hardware implementation's constraints.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

We claim:

1. A method for improving automated transformation of spoken information comprising narrative text into a written and structured report, said method comprising:
transforming the spoken information using automated speech recognition to produce a preliminary textual representation;
transforming the preliminary textual representation into a normalized input sequence with reduced complexity by:
isolating its separable original words and concatenating these into a pre-reduction input sequence;
replacing numerical elements and tuples expressed as individual words in a copy to a constrained subset of tokens, and replacing variant instances of abbreviations in the copy with an additional token, thereby forming a normalized input sequence;
applying a second transformation that replaces individual words in the copy with the appropriate token for one of the three classes of known vocabulary, rare word, and reducible word, thereby creating a tokenized input sequence;
identifying in the tokenized input sequence any preamble containing metadata to be excluded from the narrative text portion of the written report;
removing that preamble from the tokenized input sequence; and, finally,
restoring punctuation to the tokenized input sequence.

2. A method as in claim 1, wherein the step of restoring punctuation to the tokenized input sequence further comprises:
identifying for each token within the tokenized input sequence whether any punctuation element should be present after that token; and,
if one should be present, further identifying which specific punctuation element from any of the set of period, colon, and comma should be present and placing that specific punctuation element after that token.

3. A method as in claim 2, further comprising
restoring for each token within the tokenized input sequence its separable individual and original word present in the pre-reduction input sequence; and,
transforming the tokenized input sequence into punctuated narrative text for processing into the written and structured report.

4. A method as in claim 1, wherein the step of applying a second transformation that replaces individual words in the copy with the appropriate token for one of the three classes of known vocabulary, rare word, and reducible word, thereby creating a tokenized input sequence, further comprises for each word in the normalized input sequence:
applying a vocabulary reduction algorithm working from the longest to the shortest length of affixes that capture the semantic and morpho-syntactic information of the vocabulary used in the field of the narrative text which compares these affixes against that portion of the word containing the length of that affix plus four characters;
upon finding a first match for an affix, replacing the matched characters forming that portion of that word with a token for that affix;
repeating the comparison until the first of (i) finding a match for all characters but four of the word, or (ii) completing a comparison of all affixes, occurs;
if any match has been found, replacing characters not in the found affix with a stem token consisting of a positive and even-number of characters;
if only one class of affix has been found, concatenate affix and stem tokens as a single token, assign it the position of that word in the normalized input sequence and return that token;
if both a prefix and a suffix have been identified for a word:
split the stem token in its middle into a first and second part;
concatenate an ending split token to the end of the first part; and,
concatenate to the front of the second part a starting split token; and,
return both parts, assigning to each the position of that word in the normalized input sequence;
but if no match for any affix has been found, replace that word with a standard stem token to which is appended a length token determined by the count of graphemes for that word and then returning that, assigning to it the position of that word in the normalized input sequence.

5. A method as in claim 1, wherein the step of identifying in the tokenized input sequence any preamble containing metadata to be excluded from the narrative text portion of the written report further comprises:
creating from the tokenized input sequence an initial segment of a fixed size;
initializing a split tag with a zero value;
assigning to the token in the initial segment having an ordinal value of the split tag plus one, a tag given a binary value of positive or negative depending on whether that token is inside a preamble or inside a main text sequence;
if that token has been assigned a negative tag, returning the value of the split tag, but if that token has been assigned a positive tag, incrementing the split tag by one;
repeating the step of assigning the binary tag for each token in the initial segment until either the value of the split tag has been returned or is equal to the fixed size; and,
identifying all tokens in the tokenized input sequence whose ordinal value is less than or equal to the split tag as belonging to the preamble and all others as belonging to the narrative text.

6. A method as in claim 5, wherein the step of assigning to the token in the initial segment having an ordinal value of the split tag plus one, a tag given a binary value of positive or negative depending on whether that token is inside a preamble or inside a main text sequence, further comprises:
for each token taking from the location of that token an embedding of a subsequence of the words in the normalized input sequence;
feeding that embedding into a pretrained bidirectional long short term memory neural network (Bi-LSTM) fully connected to a softmax-activated output layer that produces the binary value;
not enabling backpropagation to update the pretrained embedding layer after that embedding has been fed into the Bi-LSTM; and,
attaching the tag produced by the Bi-LSTM to the token.

7. A method as in claim 1 wherein the step of restoring punctuation to the tokenized input sequence further comprises:
for each token from its location taking an embedding of a subsequence of the words in the normalized input sequence;
feeding that embedding into a pretrained bidirectional recurrent neural network (BRNN) with gated recurrent units that establish long range dependencies for the word represented by that token;
concatenating the output of both separate directional recurrent neural networks (RNNs) of the BRNN;
feeding that concatenation to a pretrained separate RNN having an attention mechanism to assist with capturing relevant contexts;
applying, to both the concatenation and the pretrained separate RNN, for each token at its location within the tokenized input sequence, an attention mechanism;
effecting a late fusion combining the output of the attention mechanism and the current position of that token within the tokenized input sequence being processed by the BRNN without interfering with its memory, that produces the punctuation decision identifying whether any punctuation element should be present and if so, which specific punctuation element should be present after that token in the tokenized input sequence; and,
then inserting after that token an output representing the punctuation decision.

8. A method as in claim 7 further comprising:
training each RNN to replace a word with its rare class whenever that word is found no more than twenty times in any set of training data; and,
omitting, whenever a word is found no more than one hundred times in any set of training data, the step of applying a second transformation that replaces individual words in the copy with the appropriate token for one of the three classes of known vocabulary, rare word, and reducible word, thereby creating a tokenized input sequence;
thereby reducing processing time and memory requirements for vocabulary reduction and consequently speeding the processing for all remaining transformations.

9. A method as in claim 8, further comprising:
deriving the training data from unlabeled text collected from a selection of medical reports and medical dictation transcriptions; and;
using the training data to train each RNN before its first use in an application of this method.

10. A method as in claim 8, further comprising deriving the training data from any of the set of:
collected dictations by a single author over multiple subjects;
collected dictations by multiple authors over a single subject;
collected dictations by multiple authors over multiple subjects; and,
collected dictations by any of single and multiple authors over a specific class of subject comprising any of interview, examination, treatment, syndrome, symptom, location, any of sourcing, reporting, and treating organization including all subsets even proper subset thereof, and time intervals.

11. A method as in claim 5 further comprising using the split tag to infer and effect the placement of a colon at the end of the preamble and immediately preceding the narrative text.

12. A method as in claim 1, wherein the identification of a separable original word comprises any of character-driven recognition, stroke-order-driven recognition, and vector-characteristic-driven recognition, of the word.

13. A method as in claim 7, further comprising separable processing of the embedded subsequence in any RNN using a context determined by the length of the subsequence.
